(19) United States
(12) Patent Application Publication
(10) Pub. No.: US 2016/0359637 A1
(43) Pub. Date: Dec. 8, 2016

(54) Distributed Function Hybrid Integrated Array

(71) Applicant: mPower Technology, Inc., Albuquerque, NM (US)

(72) Inventor: Murat Okandan, Edgewood, NM (US)

(21) Appl. No.: 15/176,117

(22) Filed: Jun. 7, 2016

Related U.S. Application Data
(60) Provisional application No. 62/172,203, filed on Jun. 7, 2015.
(60) Provisional application No. 62/191,940, filed on Jul. 13, 2015.

(51) Int. Cl. H04L 9/32; H01Q 3/26; H02J 3/38; H04L 9/08; H01L 31/05

(52) U.S. Cl. CPC H04L 9/3297; H04L 9/0869; H01L 31/05; H02J 3/383; H01Q 3/2658

(57) ABSTRACT

Fabrication, integration and operation of an array of micro-scale singulated electronic and opto-electronic semiconductor devices in flexible, thin and highly reliable format. The array includes power and data management devices that are distributed within the array such that each one handles only a small amount of power compared to existing systems. Thus less expensive, more reliable components can be used. These devices and systems enable novel functionality and enhanced capabilities in renewable energy, communication, sensing and control systems, such as photovoltaic arrays and phased array antennas.

### CROSS-REFERENCE TO RELATED APPLICATIONS

This application claims priority to and the benefit of filing of U.S. Provisional Patent Application Ser. No. 62/191,940, entitled “Distributed Power and data management and State-of-Health Monitoring for Photovoltaic Systems”, filed on Jul. 13, 2015, and U.S. Provisional Patent Application Ser. No. 62/172,203, entitled “Distributed Function Hybrid Integrated Array”, filed on Jun. 7, 2015, the specifications and claims of which are incorporated herein by reference.

### BACKGROUND OF THE INVENTION

### Field of the Invention (Technical Field)

The present invention is related to integration of electronic, optoelectronic and programmable functionality into flexible, highly reliable and redundant systems with applications in renewable energy, sensing and communication systems and control systems.

### Background Art

Note that the following discussion may refer to a number of publications and references. Discussion of such publications herein is given for more complete background of the scientific principles and is not to be construed as an admission that such publications are prior art for patentability determination purposes.

Microelectronic and optoelectronic functionality embodied in circuits have provided increasing levels of functionality over the last six decades, enabled by the increasingly sophisticated semiconductor manufacturing techniques. With the widely available packaging and integration approaches including flexible circuits and printed circuit boards, these semiconductor devices have been embedded in a very large variety of products. While conventional manufacturing and integration approaches have provided the necessary functionality, there are further design and functionality features that are desirable but are beyond the capabilities of current techniques. For example, power and data management features such as AC waveform generation, DC-DC conversion, module disconnect, power factor accommodation and state-of-health monitoring are currently performed by panel level integrated discrete circuits, such as those produced by Enphase, Tigo, SolarBridge, SolarEdge and others. Combined power from all the cells are typically managed by a circuit at the panel level. A critical challenge is the reliability of the power handling components, such as the transistors, diodes and especially the discrete passives such as capacitors and inductors.

Another example is manufacturing and assembly of phased array antenna and similar sensing and communication systems with large numbers of individual elements that require 1) coordinated control of individual element behavior and 2) the capacity to handle large amounts of data, both going into and coming out of such systems. While existing systems currently address these requirements by various electronic system configurations, there are limited or in some cases no solutions available for very large area, flexible, deployable systems that can withstand challenging application requirements.

At the system level, many systems have features embedded to provide necessary safety and security functionality. These usually take the form of embedded electronic and software features, such as unique identifiers, physical characteristics that are hard or impossible to duplicate, and random features that enable secure communications between the system and higher level control mechanisms. Blockchain approaches are also being utilized that allow individual data packets from multiple sources to be linked together and verified, while keeping the data publicly accessible for verification and further processing as needed. However, there is not a deep, individual element level embedding of these features for very large scale arrays that need to be integrated in various systems and form factors.

### SUMMARY OF THE INVENTION (DISCLOSURE OF THE INVENTION)

The present invention is an array of interconnected electronic or opto-electronic elements, the array comprising a plurality of power and data management devices distributed among the elements, each power and data management device connected to a subset of the elements and handling a maximum power of 1 W. Each power and data management device is preferably optically coupled to a central controlling unit or one or more array elements via an optical fiber or free space. And preferably comprises an LED, a III-V semiconductor device, or a silicon device for producing light. Each element preferably has a maximum lateral dimension of 0.5 cm, or more preferably 1 mm. The array preferably comprises a flexible substrate, such that the array is rollable or foldable. Each power and data management device preferably handles a maximum power of 0.1 W, and even more preferably 10 mW.

The elements optionally comprise phased array antenna elements or photovoltaic cells. Each photovoltaic cell preferably produces less than approximately 100 mA of current and preferably produces less than 1 W of power, more preferably less than 0.1 W of power, and even more preferably less than 10 mW of power. The array preferably comprises more than one thousand photovoltaic cells per square foot, and even more preferably more than ten thousand photovoltaic cells per square foot. Each power and data management device preferably manages power produced by a subset of the photovoltaic cells, the produced power having a voltage greater than 10 V. The power and data management devices are preferably manufactured in the same process flow as the photovoltaic cells.

The present invention is also a method for providing a secure and verifiable ledger of data produced by an array of interconnected electronic or opto-electronic elements, the method comprising distributing a plurality of power and data management devices among the elements; connecting each power and data management device to a subset of the elements; each power and data management device handling a maximum power of 1 W; and each power and data management device performing one or more security functions. The security functions are preferably selected from the group consisting of generating random numbers, providing a unique embedded identifier for each power and data management device, performing algorithms or providing cryptographic elements required to produce a blockchain or to implement blockchain functionality, providing a time stamp, and providing a counter. Random numbers are preferably generated using thermal gradients, optical inputs, electrical signals, light input levels, or a combination thereof. The security function is preferably combined with data obtained from the subset of elements. The data is preferably selected from the group consisting of power produced, ownership information, and transfer of power to other system elements. The combination of the function and the data is preferably used to produce a blockchain, which optionally comprises data supplied by elements external to the array. The ledger is preferably distributed and stored throughout the array and preferably includes one or elements selected from the group consisting of a blockchain, proof-of-capture of energy, ownership of system components, ownership of captured energy, transfer of energy, proof of ownership, proof-of-stake, proof-of-transfer, proof-of-consumption, and transactional information.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate the practice of embodiments of the present invention and, together with the description, serve to explain the principles of the invention. The drawings are only for the purpose of illustrating certain embodiments of the invention and are not to be construed as limiting the invention. In the drawings:

FIG. 1A shows a micro-cell sub-array of the present invention.

FIG. 1B shows an example of a circuit diagram of series-parallel-series connections of individual micro-cells.

FIG. 2A shows an all electrical connection device.

FIG. 2B shows an electrical-to-optical signal enabled electrical pass-gate whose transistors are gated by an optical signal.

FIG. 2C shows an optical to electrical connection in which an optical fiber is used to deliver the optical control signal to the pass-gate device.

FIG. 3 is a schematic showing how control signals routed into the array enables arbitrary configuration of the network.

FIG. 4 shows a power and data management device that can be fabricated in the same manufacturing process flow as solar cells.

FIG. 5 shows power and data management devices assembled onto a cell sub-array.

FIG. 6 shows a power and data management device assembled onto a receiver substrate.

FIG. 7 shows a light gated pass-gate device.

FIG. 8 shows a capacitively coupled electrical signaling device.

FIG. 9 shows an optical signaling embodiment for delivering data and power through an optical fiber.

FIG. 10A shows a III-V semiconductor device integrated on a silicon device incorporating through-silicon-vias.

FIG. 10B shows the device of FIG. 10A integrated on a flexible substrate.

FIG. 11 shows a III-V semiconductor device integrated on a silicon device without through-silicon-vias.

FIG. 12 shows optical coupling of data to and from individual array elements.

FIG. 13 shows management of optical and thermal properties of an integrated assembly through the use of the polymer and metal layers.

FIG. 14 shows a sub-array comprising power and data management elements which is part of a larger assembly of devices and components.

FIG. 15 shows a solar module comprising the sub-arrays described in FIG. 14.

FIG. 16 shows examples of interconnections of micro-solar cells.

### DETAILED DESCRIPTION OF EMBODIMENTS OF THE INVENTION

The ability to control individual elements in a large array is important for achieving the high level of performance desired in many applications, ranging from phased array radar/communication systems, detection and imaging systems and energy harvesting/power and data management systems. The present invention describes manufacturing techniques, methods and devices that enable control of individual elements or groups of elements and achieve additional system level benefits. Electronic and/or opto-electronic elements are fabricated and integrated using semiconductor manufacturing techniques that remove a key physical challenge facing semiconductor devices: brittleness. High performance semiconductors are typically manufactured on crystalline substrates, which are extremely sensitive to mechanical and thermal shocks that could fracture and destroy such devices. Semiconductor devices get packaged in mechanically hard and robust substrates that eliminate or mitigate most of these physical challenges. An embodiment of the present invention uses micro-scale singulated individual semiconductor elements, ranging from a few microns to several mm in lateral dimension and sub-micron to 100 um thickness, and polymeric insulators, conductors and/or metallic interconnects to create extremely robust and reliable systems. Layers of these elements are then further assembled to create more complex and higher functionality systems.

As used throughout the specification and claims, the term “power and data management” means power and data management, power control, AC waveform generation, DC-DC conversion, module disconnect, power factor accommodation, fault-detection/mitigation, state-of-health monitoring, local data storage, local data processing, management of control, sensing, safety and security data, and the like.

### Solar Arrays

Embodiments of the present invention are methods and systems that enable integration of critical functionality that is supported and enabled by semiconductor devices at the deepest level possible in the system. As an example, a photovoltaic power system of the present invention distributes and integrates power and data management functions at the lowest level possible inside a solar array—potentially down to the single micro-cell level, improving reliability since each component handles smaller amounts of power, and lowering cost since smaller devices are easier and cheaper to integrate into the system during the manufacturing of the cells, sub-array elements and/or the assembly substrate receiving the cells.

Each standard Si cell (156 mm pseudo-square) typically generates on the order of 4.5 to 5 W under AM1.5G illumination and standard testing conditions. The maximum power point voltage (Vmpp) is on the order of 0.55-0.6V per cell, and maximum power point current (Impp) is on the order of 7.5-8.3 A. In current systems, it is advantageous to maximize the power output per each such low voltage high current cells to maximize the efficiency of the system and reduce system costs.

In contrast, in embodiments of the present invention, instead of using standard solar cells, many micro-cells (e.g. hundreds to thousands) are interconnected in a highly redundant and fault tolerant, multi-tiered series-parallel topology. For example, in the footprint of one standard 6″ square solar cell, the present invention can include over 20,000 cells. Each micro-cell preferably produces less than 1 W, more preferably less than 0.1 W, and even more preferably less than 10 mW, and even more preferably less than 1 mW. This enables similar power generation per unit area of footprint, but in contrast to existing systems, the power is now available in high voltage, low current format, on the order of 10 to 1000 V per one standard (6″×6″) cell area, completely arbitrarily selectable for optimization of the desired system parameters. This means that power and data management devices only have to tolerate very small currents, and are thus far more reliable than devices currently used. In addition, because the currents are so low, less metal is required for interconnects, thereby reducing system cost.

Power and data management functions are preferably integrated into the system at the sub-array level by integration of circuits (integrated circuits or other IC/passives combinations) at the desired points. This integration can be performed by pick-and-place methods, or by selective transfer of these components from a wafer, or another assembly onto the cell assemblies, or onto the receiving substrate which will then receive the cell assemblies. In systems, the common failure points are typically the interconnects and discrete components (such as capacitors and inductors). By using the best materials and processes for creating the interconnects and minimizing or completely eliminating passive components, the present invention significantly improves the reliability of the overall system.

Embodiments of the present invention have the ability to distribute signals into and collect signals from such an array such without running into high voltage to low voltage line electrical breakdown issues (arcing, shorts, etc.). The distribution of signals can be accomplished electrically or optically or both. Electrically, a low-voltage signaling line is preferably used, separate from the power delivery lines (+ and −, high and ground, etc.); alternatively a capacitively coupled signal on the power line may be used for data communications to and from the local array components. These components could be as simple as a single switch (transistor, etc.), or could be more complicated circuits that accomplish higher level functions such as data collection, storage, processing and delivery to other units/to a central controller. A combination of electrical and optical configurations may utilize a low-voltage signal level (3.3V or 5V) that is delivered to a locally integrated light source (such as an LED) which then turns on or off an electrical component (such as a light-gated power transistor). This enables arbitrary interconnection of arrays of cells at higher voltages without having to worry about voltage level references for the components (e.g. power transistors) at each location, and achieves the desired voltage isolation between low-voltage and high-voltage lines. An optically driven system preferably uses a fiber to distribute the signal to the local array elements, and data collection is also preferably enabled over the same fiber using different encoding schemes (time division, code division, wavelength division, etc.). Local light emitting elements (LEDs, etc.) are preferably used to signal back on the same fiber through simple, inexpensive, and reliable coupling elements embedded in the array. The small amount of power (on the order of a few mW to 10 s of mW) that is needed to run the local components is preferably harvested from a small subset of the sub-array. It is also possible to draw that small amount of power from the electrical signaling line or from the optical signaling line.

The control signal for a module level disconnect function preferably inherently provides a “known-safe” condition, so that when the electrical or optical signal is not present the module does not provide power to the external connections, which eliminates potential electrocution hazards.

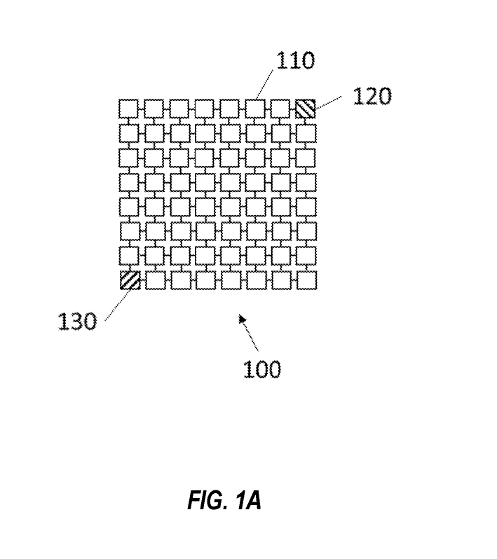

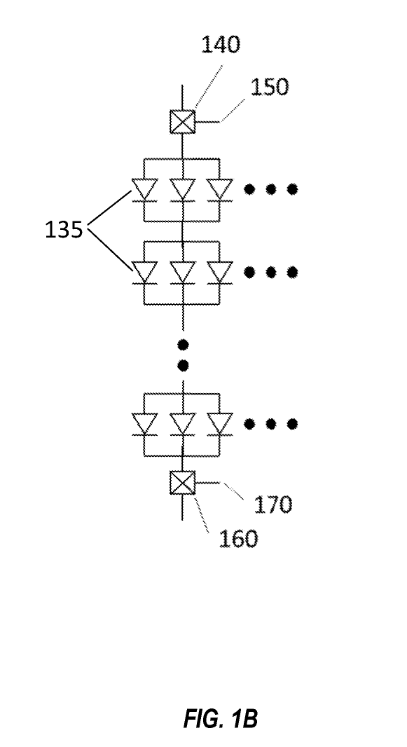

Cell sub-array 100 is shown in FIG. 1A where micro-cells 110 are arrayed in a predetermined physical outline and power and data management devices such as connection devices (high-side 120 and low side 130) are disposed at two locations. The sub-array produces a voltage that is larger than what a single cell would normally produce. FIG. 1B shows an example of a circuit diagram of series-parallel-series connections of the individual micro-cells 135 comprising a sub-array, and low-side 160 and high-side 140 connection devices and their corresponding control signals 150 and 170. Each connection device for each sub-array preferably needs to stand off a voltage that is nominally very low (a few volts to tens of volts), but the overall array configured by interconnecting the sub-arrays could provide much higher voltages (many tens, hundreds, or even thousands of volts). Each connection device thus will have higher reliability, giving the overall array a higher lifetime than existing arrays, which typically use only one such device for the entire array.

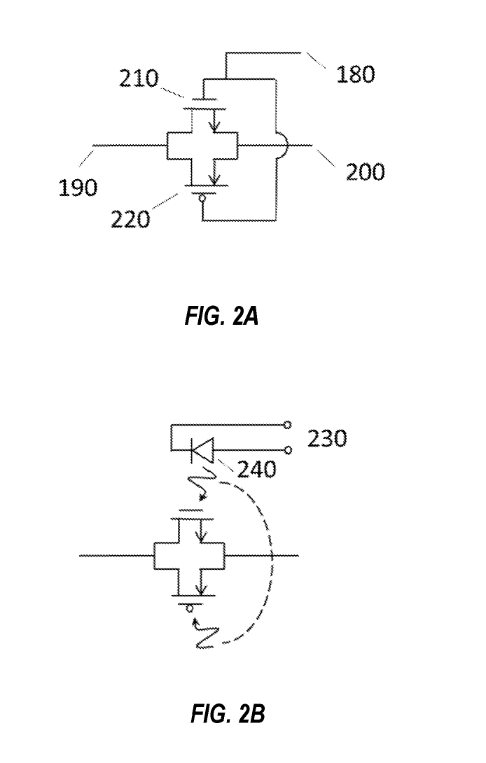

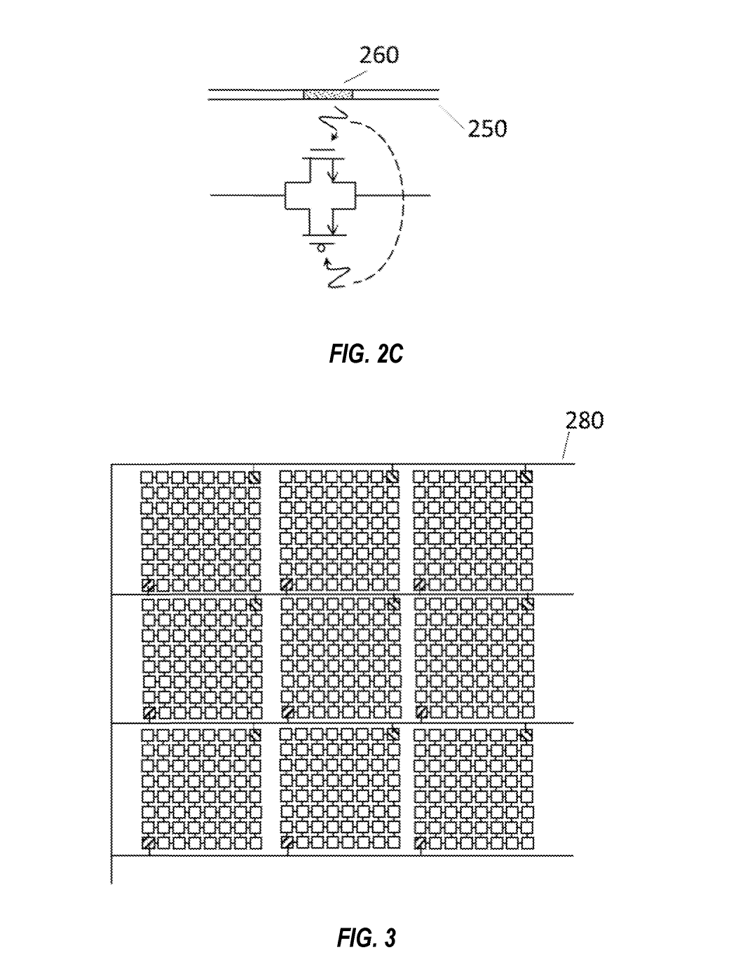

FIG. 2 shows three embodiments of connection devices formed by connecting an n-channel and p-channel device to form a pass-gate which will allow current to flow in either direction. FIG. 2A shows an all electrical connection in which control signal 180 is an electrical signal. N-type transistor 210 and P-type transistor 220 transmit power input 190 to power output 200. FIG. 2B shows an electrical-to-optical signal enabled electrical pass-gate whose transistors are gated by an optical signal generated by light emitting device 240, which is driven by electrical signal 230 that is preferably independent of the power input and power output signals and voltage levels. This enables a low voltage (for example, 3V to 5V) and a ground line to be routed into the array to control arbitrary voltage levels in the interconnection network. FIG. 2C shows an optical to electrical connection in which optical fiber 250 is used to deliver the optical control signal to the pass-gate device. This light can optionally be generated by a centrally located structure in the array. Light coupling feature 260 can be wavelength independent or wavelength selective, which allows control of the array by multiplexing different wavelengths into a single fiber or by physically separating optical signals into fibers at the centrally located control structure.

FIG. 3 is a schematic showing how control signals routed into the array enables configuration of the network in arbitrary fashion. Physical interconnection of the sub-arrays determines which configurations are possible, and the control signals select the desired configuration. The system requirements for specific applications are met by determining the desired physical layout and control methodology, fabricating the structures and operating them with the optimum and variable control algorithms. Preferably the same control signal path 280 is routed to all sub-array components (high side and low side). In this embodiment the commands sent to each individual sub-array component may be different for each component, enabling arbitrary configuration of the overall array. Power output connections are preferably independently configurable from the control signals. Independent control signals may alternatively be routed to each element (high or low side).

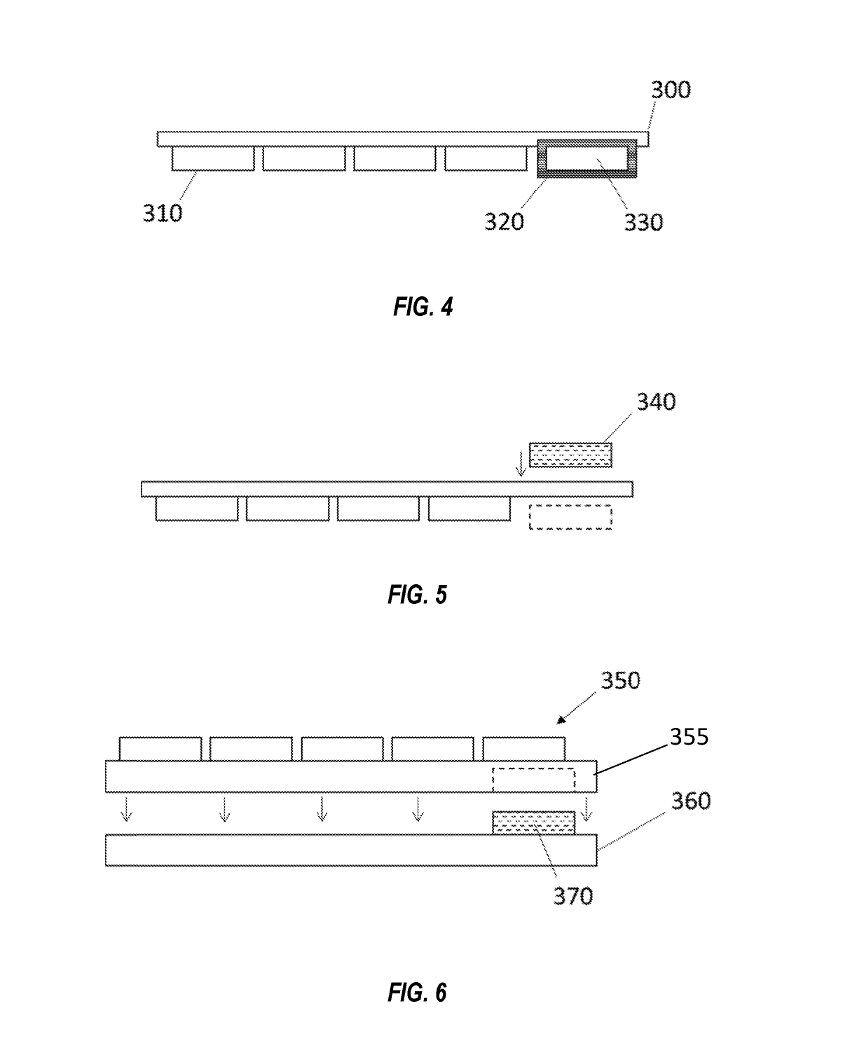

FIG. 4 shows a power and data management device that can be fabricated in the same manufacturing process flow as solar cells. Micro solar cells 310 and circuitry necessary for controlling the power, monitoring the functionality, and communicating the information to and from power and data management state-of-health monitoring component 330 are formed in the same process flow, which singulates all devices as necessary and provides the electrical connections among elements. Light blocking layer 320 is preferably deposited on components that are light sensitive to prevent undesirable operation conditions. Polymeric layer 300 provides the flexible insulating substrate and top cover layer, and metal layer(s) provide the electrical interconnects.

FIG. 5 shows power and data management and state-of-health monitoring components 340 assembled onto the cell sub-array, either on the same side as the micro-cells or on the opposite side. The interconnects are preferably formed by soldering, deposition and curing of conductive epoxy or by deposition of metal layers that connect the metal layers in the cell sub-array and the conductive traces on the assembled components.

FIG. 6 shows a power and data management and state-of-health monitoring circuit or device 370 assembled onto receiver substrate 360 that may be rigid or flexible. This assembly can be done with conventional pick-and-place tools and materials or by other means such as selective release and transfer directly from a wafer. The micro solar cell array or sub-array 350 on substrate 355 can then be assembled onto receiver substrate 360 as shown with the two substrates touching and device 370 either embedded in substrate 355 or on the bottom of receiver substrate 360, or with receiver substrate 360 disposed on sub-array 350, in which case some cells are preferably omitted to accommodate device 370.

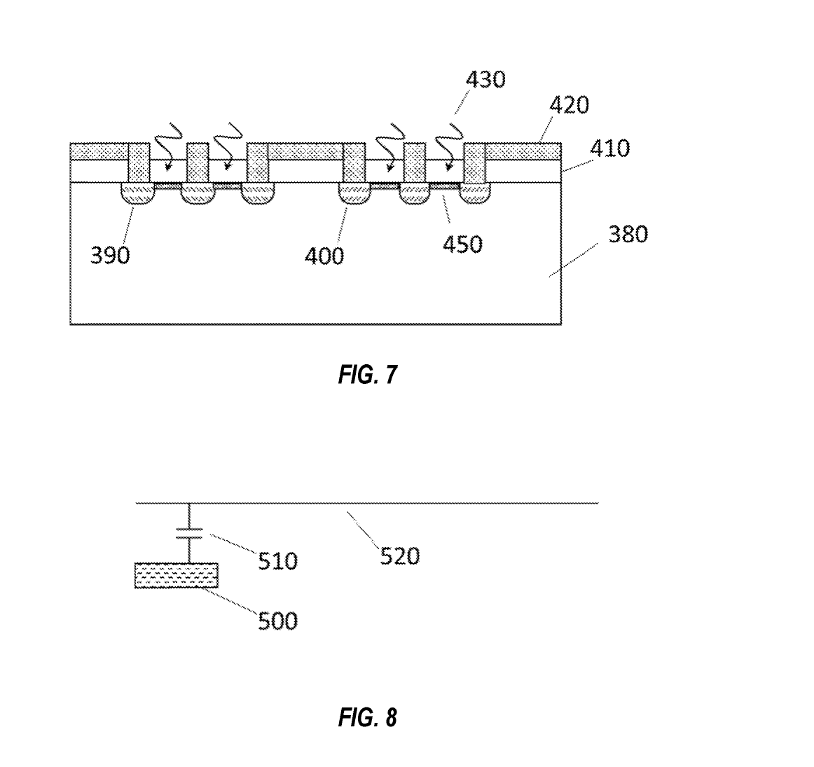

FIG. 7 shows an example of a light gated pass-gate device, where n+ junctions 390 form one portion and p+ junctions 400 form the other portion of the device. With light 430 incident on the device, photogenerated carriers form channels 450 that allow conduction among the desired junctions. Metal layers 420 or other light blocking layers and openings formed on these layers preferably define where the photogenerated carriers are located. These light gated nMOS and pMOS devices can be manufactured in the same process flow as the solar cells. Substrate 380 preferably comprises a lightly doped n-type or p-type silicon substrate. Insulating layers 410 such as silicon dioxide and/or silicon nitride provide the necessary electrical insulation and passivation on substrate 380 and between junctions 390, 400 and metal layers 420.

FIG. 8 shows an electrical signaling embodiment comprising capacitive coupling 510 for delivering data from the electrical signal or power or ground line 520 into and out of power and data management and state-of-health monitoring device 500.

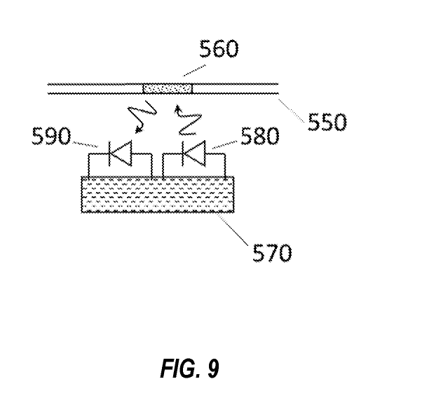

FIG. 9 shows an optical signaling embodiment for delivering data and power through optical fiber 550 and coupling structure 560 disposed in, on, and/or around the fiber. Light coupled out from fiber 550 is incident on photodiode 590 connected to or built into state-of-health monitoring and power control device 570 for providing incoming information and/or power. Light generated by light generating device 580 attached or built into state-of-health monitoring and power control device 570 is incident onto coupling structure 560 and fiber 550 for providing information and/or power back from device 570 to the central controlling unit or other array elements.

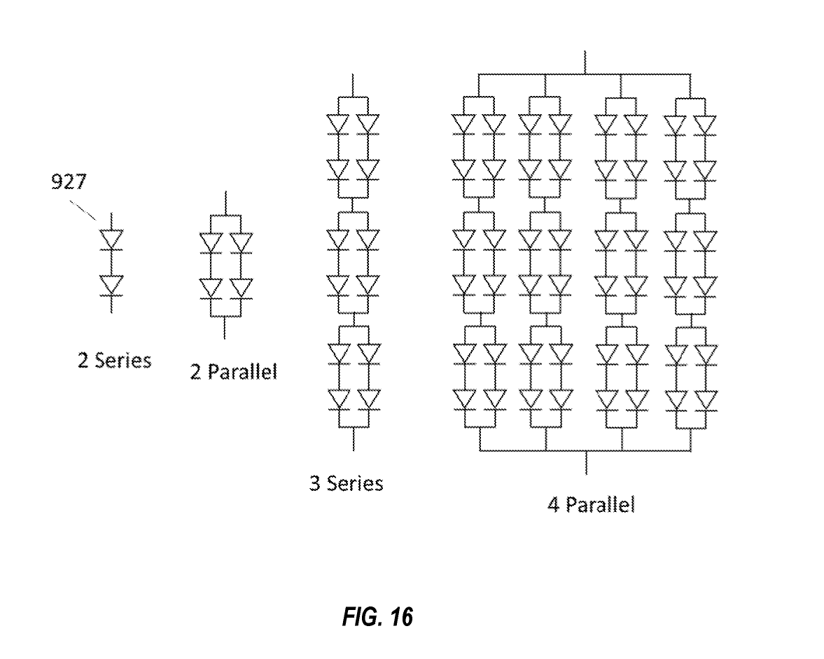

In embodiments of the present invention, the very large number of small size cells, preferably on the order of 1 mm lateral dimension or less, are interconnected very differently from how conventional solar cells are interconnected. In current practice, solar cells are interconnected in series to achieve a desired sub-module string voltage, and then connected in parallel to fill out the module footprint. Then these modules are interconnected in series to achieve module level string voltage which connects to inverters or other next stage power handling components. With micro-cells of the present invention, the cells are interconnected in small multiples to form smaller subsets which are then further interconnected in varying series-parallel combinations that confer higher system reliability, shading tolerance, robustness against component variations or failures which is not feasible with larger scale cells. For example, as shown in FIG. 16, micro-solar cell 927 is connected in series with another micro-solar cell to form a “2 series” configuration. This unit is then replicated and connected in parallel to form the next “2 parallel” set, which is then replicated 3 times and connected to form the next “3 series” set, which is then replicated 4 times and connected in parallel to form the next “4 parallel” set. These units are repeated multiple times to reach the desired system configuration in terms of voltage, current and area coverage. These interconnections are fabricated all at once in the process, which greatly simplifies manufacturing, reduces costs and increases reliability.

### Embedded Electronics Integration and Control Management and Processing for Very Large Arrays

All commercially available semiconductor components are typically fabricated in wafer format, ranging in size from 50 mm to 300 mm, and possibly 450 mm in the near future. Once device fabrication is complete, individual elements are singulated, packaged, arranged in various formats (carrier trays, waffle packs, tape, etc.) and assembled into circuits on flexible or rigid substrates. These circuits are then assembled into sub-systems where the form-factors associated with the system usually prevent accommodation of large, deployable structures.

An embodiment of the present invention integrates necessary wiring, interconnection, protection (environmental, radiation, etc.) features into a flexible, lightweight assembly of arbitrary size starting from the wafer format and opens up new design paradigms that are not feasible in conventional integration approaches. By using large, redundant and inter-mixed functions such as power, signal processing, storage, local and long-range communication through RF and opto-electronic means, a system can surpass conventional systems on all performance metrics.

System elements formed in this approach have various size options, starting from a single diode on the order of 0.1-micron to a full wafer, at 300 mm diameter. These elements are also tile-able, allowing creation of arbitrarily large systems from these elements.

Reliability of electronic and opto-electronic systems are critically dependent on the interconnects among the elements. Connections of the present invention are preferably manufactured using the highest quality and stability materials and processes used in IC manufacturing to provide the highest possible reliability. The inherently distributed nature of the systems as described here provides an additional level of resiliency that is beyond what is possible with a single IC or conventionally assembled systems.

System level mechanical resilience benefits are added by using individual elements that are on the order of less than a micron to several mm lateral dimensions and sub-micron to 100 micron thick embedded in a polymer or composite material matrix, and using silicon as an integral substrate for accommodating less robust semiconductor layers, such as III-V and II-VI materials. Through silicon vias allow interconnections to be formed among all components in this assembly without the need for wirebonds or other less robust interconnection methods.

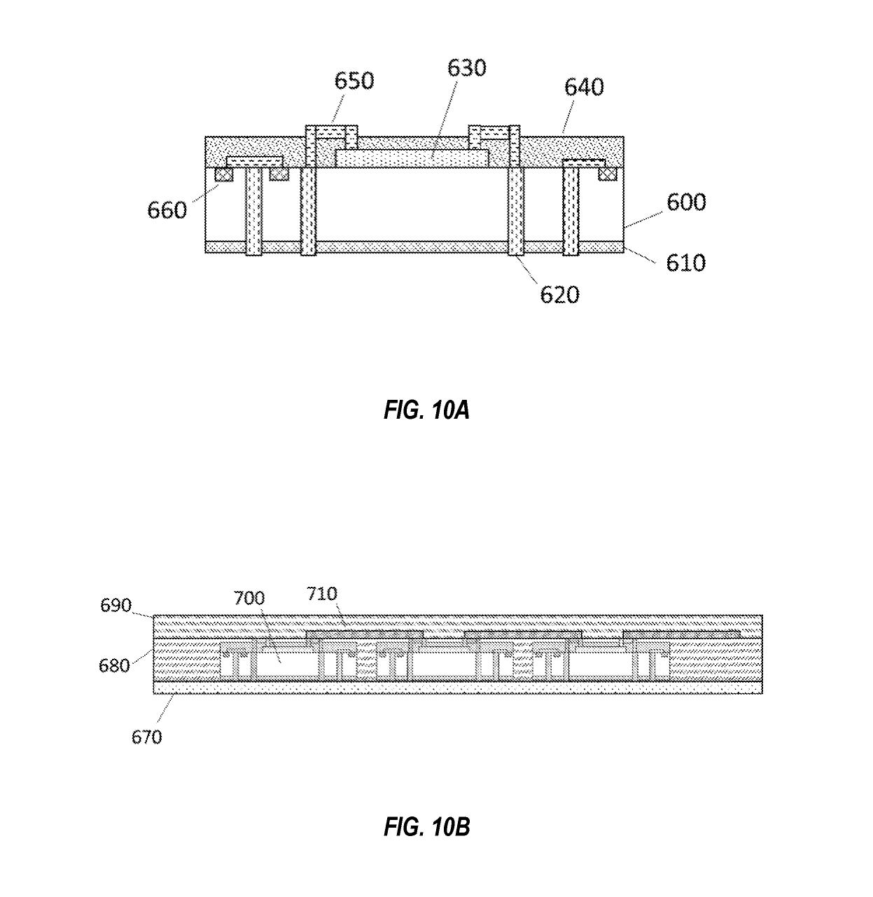

FIG. 10 shows an example of integration of III-V semiconductor devices on a silicon device with through-silicon-vias and their subsequent integration into an array with insulating polymer-metal interconnects. In FIG. 10A, III-V semiconductor device 630 is integrated on a silicon device built in silicon substrate 600. Through silicon vias 620 provide connections between the top and rear surfaces of the device, with metal interconnects 650 connecting silicon circuit elements 660 and III-V circuit elements in device 630. Polymeric or other insulating layer 640 provides electrical insulation and a mechanical substrate for creating these connections. Thin film layer 610, preferably comprising a material such as silicon dioxide, silicon nitride or a polymer, provides electrical insulation between substrate 600 and the next layer of assembly. FIG. 10B shows the next stage of assembly where the integrated silicon and III-V devices 700 with through silicon vias are assembled on flexible substrate 670. Polymeric layers 680 and 690 provide electrical insulation and enable mechanical integration of multiple devices. Metal lines 710 deposited on devices 700 and insulating layer 680 connect devices on the top side, while the electrical connections in substrate 670 and through-silicon-vias in device 700 create further connections.

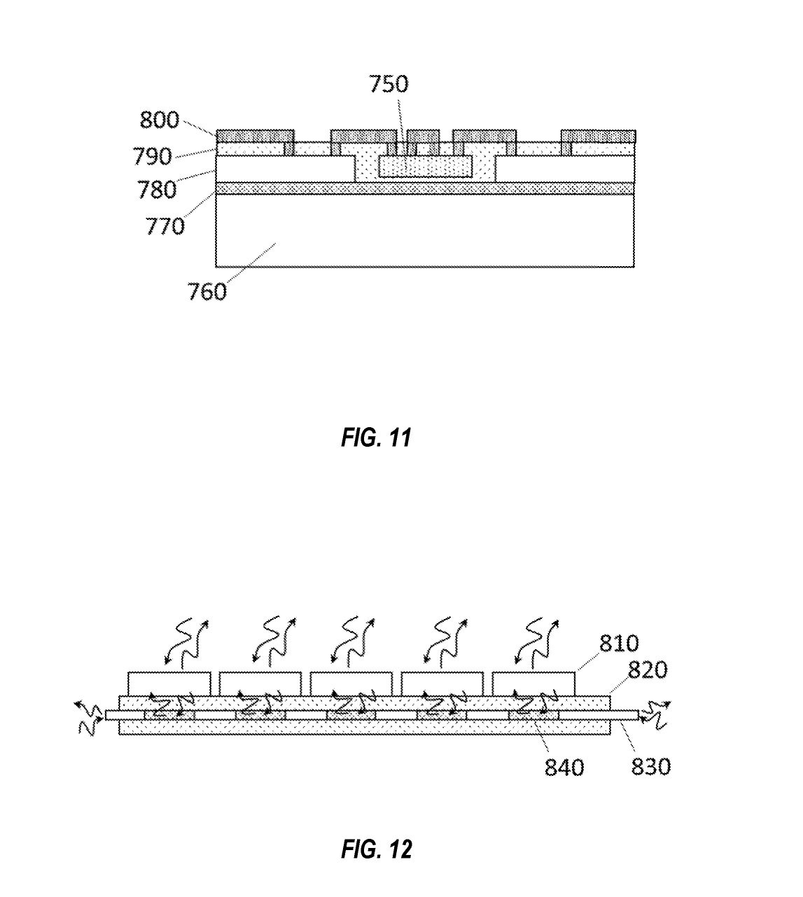

FIG. 11 shows an alternative embodiment of the integration approach without through-silicon-vias. III-V semiconductor device 750 is embedded on or inside silicon on insulator wafer 760, which comprises insulting layer 770 and other silicon devices built in device layer regions 780. Polymeric electrically insulating and planarizing layer 790 holds device 750 in place and allows electrical connections to be formed among various regions with metal layer 800.

FIG. 12 shows delivery of data to and from individual array elements 810 via optical coupling through fiber 830 or by free-space means. To facilitate distributed functionality, a high bandwidth and easily addressable communication system is necessary, which is implemented through optical interconnections in this embodiment. Light is generated by III-V devices integrated in array elements 810, and detection is accomplished by III-V devices and/or silicon devices. Light is transmitted through integrated fibers such as fiber 830 or via free-space, depending on system requirements. Encoding and encryption of information for each element is accomplished by implementation of a variety of algorithms, embedded hardware functions in elements of the array, and in the higher levels of the system. Electrical local and long range data and power connections are formed in flexible substrate 820, which may comprise embedded fibers 830. Light in the fibers is coupled out by features 840 built in, on, and/or around the fibers. Features 840 also enable light generated by array elements 810 to be coupled back into fiber 830. Locally stored array configuration information and other local functionality enables high performance operation of such an array with simplified control methodology.

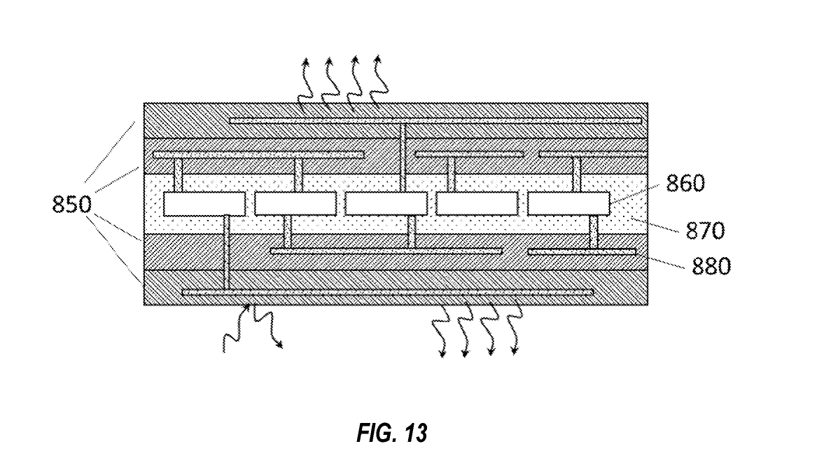

FIG. 13 shows management of optical and thermal properties of the assembly through use of the polymer and metal layers. Certain IC chips are sensitive to photogenerated currents that would be created by incident light. To prevent undesirable operation, these chips are coated with metals or other opaque materials in the assembly 870, such as metal traces 880 in the flexible structure. The same features also assist in thermal management of the array, as they provide thermally conductive paths. A combination of thermally insulating, conducting and thermally switchable structures allow highly granular control of the thermal conditions in the system that enable very unique system performance options, such as micro-annealing of elements in an array. Multiple polymeric electrically insulating and metal trace layers 850 are preferably assembled around array elements 860.

An example of this capability is generation of power with solar cells, as described above. With the addition of higher functionality elements, it is possible to generate arbitrary functionality with this approach, such as locally generating power, signals, communication and control functions for a phased array antenna and sensor structure. In this case, the ability to handle radiated or received power locally means that each power electronics component does not have to accommodate high power levels. For example, in a phased array antenna of the present invention, each power and data management component is configured to handle less than 1 W, more preferably less than 0.1 W, and even more preferably less than 10 mW, and even more preferably less than 1 mW. This reduces costs, since components with lower specifications, but that have higher reliability, may be used.

A critical capability for some of the applications in extreme environments will be the ability of the system to survive and function in a radiation environment such as space applications. This is enabled by several different features of the method and system described here. At the circuit level, rad-hard or rad-tolerant ICs and designs provide the basic capability. Specific integration approach of a large array with multiple redundant copies and distributed functionality add another layer of system robustness. Metal and/or polymer layers integrated into the assembly allow energetic particles to be stopped or deflected and mitigates some of the radiation effects.

Mechanical properties of the structure are arbitrarily adjustable through selection of the matrix elements. Silicon, other semiconductor chips and circuit elements are preferably selected to be less than a micron to several millimeters depending on system needs and the polymers, metals and composite structures provide the necessary and desired mechanical properties. Size scale of the individual elements allow the flexible structure to be rolled, folded or otherwise compacted and deployed in ways that are not possible with other electronic, optoelectronic and thermal structures.

Ability to arbitrarily shape and locate elements opens up a very large design space that has not been accessible with conventional design approaches for antennas and sensor arrays. Slot antennas, multi-element sub-wavelength apertures that can be combined to provide complex radiation patterns, non-planar designs are enabled with the described technology and design methodology.

### Safety and Security Features

In embodiments of the present invention, advanced safety and security features are enabled by the integration of unique component identifiers, random number generators and other functions in array elements, control and sensing units within the array and within the system level control architecture. Unique identifiers are preferably built into the elements during manufacturing and can be further modified, as a one-time write or multiple times through software while in assembly, shipping, installation and/or during operation in the field. Integration of multiple semiconductor device types enables a mix-and-match capability between these devices to achieve the desired functionality, such as optical-electrical coupled functions, thermally driven functions or combinations thereof. Random number generators preferably utilize device level variability and random signals that are available in the operational environment such as thermal gradients, optical inputs, electrical signals and their combinations to create random numbers to prevent spoofing of a time stamp. Another key feature is the integration of key functions necessary for blockchain functionality in the deepest level possible in this system configuration, and the ability to partition and move these functions within the array in a dynamic fashion. For example, data blocks generated by the solar power system indicating capture of certain amount of energy (joules, watt-hours, etc.) can be embedded with time-stamp, counter, unique identifier information and random numbers and passed onto the other system components for the necessary processing. Additional data payloads can also be embedded into this data stream that are provided from an external source, allowing secure, verifiable recording and distribution of data in a distributed, publicly available ledger system. The energy cost of transmitting the additional data into the system, processing and any other system overhead costs are preferably then compensated for by a self-enforcing, smart contract function embedded into the system. Proof-of-capture that is indicated by the data generated and subsequent processing by this system and/or other distributed elements enable highly decentralized, very robust and uniquely functional energy management and data processing systems.

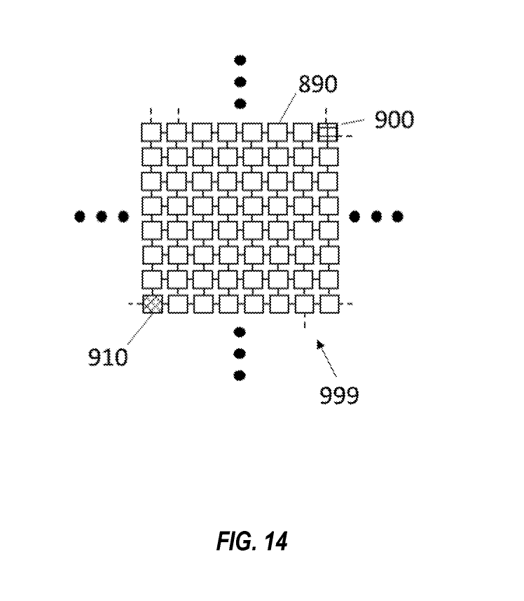

FIG. 14 shows sub-array 999 which is part of a larger assembly of devices and components. Array elements preferably provide different functions; for example, element 890 could comprise a solar cell generating power, and elements 900 and 910 could measure and record amount of power being generated by sub-array 999. The connections among the elements are preferably created at the time of manufacturing and assembly, and can be further modified by the power and data management functions build into the elements, such as elements 890, 900 and 910. Tracking and recording of power generation and other system parameters are preferably tracked by combining time-stamp information generated locally or provided by an external signal if necessary, internal counters and memory elements, random number generator(s) and unique identifier(s). The random number generation and unique identifier generation are preferably provided by light input levels across the array, local RF and thermal fields, variations in solar cell characteristics and purpose-built features in the array and embedded circuitry that minimize energy consumption. The local collection and processing of data is carried out by algorithms that are hard-wired into the system or by instructions that are delivered from an external source with proper authentication and validation. Parts of the blockchain algorithm are preferably carried out locally inside the sub-array and in concert with other elements in the system, while other higher system level functions are preferably handled by a control system external to the local system.

The blockchain function is preferably implemented by creating blocks of data with unique identifiers, random numbers, other data and/or executable program elements, and any other digital information desired. This data block is preferably processed through an algorithm which assigns a unique feature that is also embedded into the data block. The algorithm or the function for generation of the unique feature is preferably carried out in part or whole by the elements in the array or sub-array or in combination with other elements in the larger local system or by the widely distributed system. The widely distributed system comprises other computing, storage or processing elements in any location, with the proper communication, safety and contractual procedures implemented. The next data block that is generated uses the features in the previous data block, including but not limited to the unique identifiers, executable code, cryptographic elements such as hash codes and links the previous and other concurrent data blocks together to form a chain that is computationally and energetically very expensive to replicate or tamper with. Linking of capture of energy as proof-of-capture, ownership or assignment as proof-of-ownership or proof-of-stake, transactional information as proof-of-transfer or proof-of-consumption creates a physically instantiated activity chain that is also used to embed other desirable information into this energy, information flow and recording system. The large distributed system includes other elements, which in this embodiment use the energy that is generated by the solar cells or energy coming from other sources, verify, record and transmit their activity in the form of elements in the above described blockchain or a similar functional implementation. Physical connectivity of the elements is arbitrarily defined, by embedded physical connections with a minimum of two wires between elements, sub-array and system elements, including but not limited to a local ground and one wire arrangements, which are then reconfigured through commands and locally implemented functions in the hardware that modify the connections. In addition, the connectivity for transmitting power and information is also preferably enabled by wireless means embedded in the elements and the system, including but not limited to electromagnetic (terahertz, optical, millimeter wave, RF), thermal and acoustic coupling.

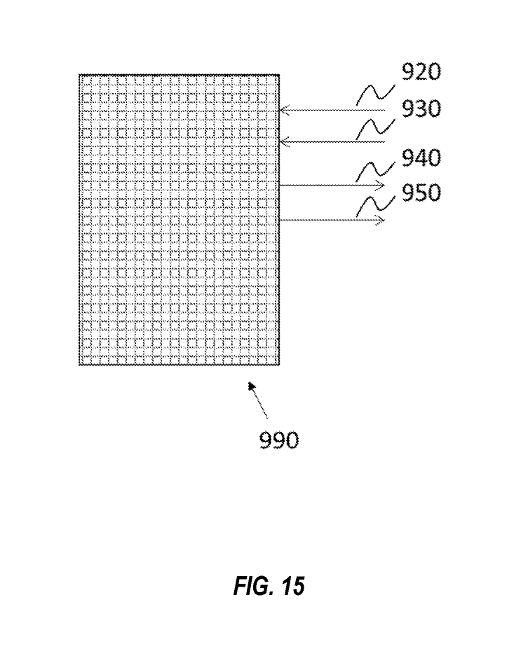

FIG. 15 shows solar module 990 comprising the sub-arrays described in FIG. 14. Power in 920 and data in 930 deliver necessary inputs into the system for the desired functionality, including safety and security features. Power out 940 and data out 950 provide the desired outputs of the system. In one embodiment, solar module 990 is part of a larger power and computing system, performing the desired local functions in support of the overall system function. For the distributed ledger functionality, such as a blockchain, proof-of-capture of energy, ownership of system components, ownership of captured energy, transfer of energy, transfer of ownership and other functions can be locally performed within this module, and in concert with other system elements. The distributed ledger functionality is preferably accomplished by storing parts or whole of the blockchain data in multiple copies in desirable storage elements in the larger system which ensures safety and security of the system by allowing distributed access, verification and maintenance of the blockchain information. In a public blockchain, this information is freely accessible by any system connected to the communication network where the blockchain functionality is implemented. It is also possible to implement private blockchains, where the distributed information is only accessible by the properly authorized and verified entities. The public blockchain also allows private information to be stored in the open blockchain through cryptographic means.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. An array of interconnected electronic or opto-electronic elements, the array comprising a plurality of power and data management devices distributed among the elements, each power and data management device connected to a subset of the elements and handling a maximum power of 1 W.

2. The array of claim 1 wherein each power and data management device is optically coupled to a central controlling unit or one or more array elements via an optical fiber or free space.

3. The array of claim 2 wherein each power and data management device comprises an LED, a III-V semiconductor device, or a silicon device for producing light.

4. The array of claim 1 wherein each element has a maximum lateral dimension of 0.5 cm.

5. The array of claim 4 wherein each element has a maximum lateral dimension of 1 mm.

6. The array of claim 1 comprising a flexible substrate, such that the array is rollable or foldable.

7. The array of claim 1 wherein each power and data management device handles a maximum power of 0.1 W.

8. The array of claim 7 wherein each power and data management device handles a maximum power of 10 mW.

9. The array of claim 1 wherein the elements comprise photovoltaic cells.

10. The array of claim 9 wherein each photovoltaic cell produces less than approximately 100 mA of current.

11. The array of claim 9 wherein each photovoltaic cell produces less than 1 W of power.

12. The array of claim 11 wherein each photovoltaic cell produces less than 0.1 W of power.

13. The array of claim 12 wherein each photovoltaic cell produces less than 10 mW of power.

14. The array of claim 9 comprising more than one thousand photovoltaic cells per square foot.

15. The array of claim 14 comprising more than ten thousand photovoltaic cells per square foot.

16. The array of claim 9 wherein each power and data management device manages power produced by a subset of the photovoltaic cells, the produced power having a voltage greater than 10 V.

17. The array of claim 9 wherein the power and data management devices are manufactured in the same process flow as the photovoltaic cells.

18. The array of claim 1 wherein the elements comprise phased array antenna elements.

19. A method for providing a secure and verifiable ledger of data produced by an array of interconnected electronic or opto-electronic elements, the method comprising:
distributing a plurality of power and data management devices among the elements;
connecting each power and data management device to a subset of the elements;
each power and data management device handling a maximum power of 1 W; and
each power and data management device performing one or more security functions.

20. The method of claim 19 wherein the security functions are selected from the group consisting of generating random numbers, providing a unique embedded identifier for each power and data management device, performing algorithms or providing cryptographic elements required to produce a blockchain or to implement blockchain functionality, providing a time stamp, and providing a counter.

21. The method of claim 20 wherein random numbers are generated using thermal gradients, optical inputs, electrical signals, light input levels, or a combination thereof.

22. The method of claim 19 combining the security function with data obtained from the subset of elements.

23. The method of claim 22 wherein the data is selected from the group consisting of power produced, ownership information, and transfer of power to other system elements.

24. The method of claim 22 wherein the combination of the function and the data is used to produce a blockchain.

25. The method of claim 24 wherein the blockchain comprises data supplied by elements external to the array.

26. The method of claim 19 wherein the ledger is distributed and stored throughout the array.

27. The method of claim 19 wherein the ledger includes one or elements selected from the group consisting of a blockchain, proof-of-capture of energy, ownership of system components, ownership of captured energy, transfer of energy, proof of ownership, proof-of-stake, proof-of-transfer, proof-of-consumption, and transactional information.
